(19) United States
(12) Patent Application Publication
(10) Pub. No.: US 2026/0051178 A1
(43) Pub. Date: Feb. 19, 2026

(54) SAFETY AND AWARENESS APPARATUS, SYSTEM, AND METHOD FOR FORWARD AND CROSS TRAFFIC DETECTION

(71) Applicant: Velvac Incorporated, New Berlin, WI (US)

(72) Inventors: Mathew WEBER, Delafield, WI (US); Mark MOELLER, Spokane, WA (US); Jeffrey DELBEKE, Sussex, WI (US)

(21) Appl. No.: 19/302,660

(22) Filed: Aug. 18, 2025

Related U.S. Application Data
(60) Provisional application No. 63/684,052, filed on Aug. 16, 2024.

(51) Int. Cl. G06V 20/58; B60R 11/00; B60R 11/04; B60W 30/095; B60W 50/14; B60W 50/16; G01S 13/931; G01S 17/931; G06V 10/764; H04N 7/18; H04N 23/51

(52) U.S. Cl. CPC G06V 20/58; B60R 11/04; B60W 30/0956; B60W 50/16; G01S 13/931; G01S 17/931; G06V 10/764; H04N 7/181; B60R 2011/004; B60R 2011/0085; B60W 2050/143; B60W 2050/146; B60W 2420/403; B60W 2420/408; B60W 2422/00; B60W 2552/20; B60W 2554/20; B60W 2554/4045; B60W 2556/40; G06V 2201/08; H04N 23/51

(57) ABSTRACT

The described technology pertains to vehicle safety systems in the field of vision and detection. A vehicle vision and detection system includes multiple cameras and/or detectors within the housing configured designed for attachment to a hood or fender of a vehicle to capture image or detection data for forward and/or cross-traffic fields of view on opposite sides of the vehicle. One or more processors are connected to the cameras and/or detectors to receive and analyze image or detection data, identify objects, assess risk levels for each identified object, and activate an output interface to alert a vehicle operator based on the assessed risk level.

### CROSS-REFERENCE TO RELATED APPLICATION

This application claims the benefit of U.S. Provisional Application No. 63/684,052, Titled: FENDER OR HOOD MOUNTED DETECTORS FOR FORWARD AND CROSS TRAFFIC DETECTION and filed on Aug. 16, 2025. The aforementioned provisional application is incorporated by reference herein.

### FIELD OF THE INVENTION

Aspects of the present disclosure relate generally to safety and convenience features for a vehicle. More specifically, the description herein relates to the mounting of a video camera system and/or detector system to the front end, such as to the hood or fender, of a vehicle, such as a heavy duty truck.

### BACKGROUND

Drivers and passengers in vehicles, especially in trucks or other commercial vehicles need to be situationally aware while maintaining concentration on the road ahead. While safety and convenience features in vehicles have improved, implementations of such systems may be complex and costly, especially in retrofit situations. Therefore, improvements to safety and convenience features and integrations thereof may be desired.

### SUMMARY

A summary of certain aspects of the disclosure is set forth below. It is worth noting that these aspects are presented merely to provide the reader with an overview of certain features and aspects, and these features and aspects are not intended to restrict the scope of this disclosure. This summary does not provide a comprehensive overview of all contemplated aspects of the disclosure and is not intended to highlight significant elements of all aspects or define the scope of any or all aspects. The purpose of this summary is to present some concepts of one or more aspects in a simplified form as an introduction to the more detailed description below.

Aspects of the disclosure relate to a vehicle vision and detection system that includes a bracket configured to be secured to a hood or fender of a vehicle, a support arm operably connected to the bracket, a housing, and a plurality of cameras and/or detectors disposed within the housing and arranged to capture image or detection data corresponding to a forward field of view and first and second cross-traffic fields of view on opposite sides of the vehicle. One or more processors are operably connected to the plurality of cameras and/or detectors and are configured to receive image or detection data from the cameras and/or detectors corresponding to the first and second cross-traffic fields of view, analyze the received image or detection data to detect objects within the first and second cross-traffic fields of view, determine a risk level associated with each detected object based on the analyzed image or detection data, and cause an output interface to provide an alert to a vehicle operator based on the determined risk level of a detected object.

Further aspects relate to a non-transitory computer-readable medium storing instructions that, when executed by one or more processors of a vehicle vision and detection system comprising a bracket configured to be secured to a hood or fender of a vehicle, a support arm operably connected to the bracket, a housing, and a plurality of cameras and/or detectors disposed within the housing and arranged to capture image or detection data corresponding to a forward field of view and first and second cross-traffic fields of view on opposite sides of the vehicle, cause the one or more processors to perform operations comprising receiving image or detection data from the plurality of cameras and/or detectors corresponding to the forward field of view and the first and second cross-traffic fields of view, analyzing the received image or detection data to detect objects within the forward field of view and the first and second cross-traffic fields of view, determining a risk level associated with each detected object based on the analyzed image or detection data, and causing an output interface to provide an alert to a vehicle operator based on the determined risk level of a detected object.

### BRIEF DESCRIPTION OF THE DRAWINGS

The novel features believed to be characteristic of aspects of the disclosure are set forth in the description that follows. The drawing figures are not necessarily drawn to scale and certain figures may be shown in exaggerated or generalized form in the interest of clarity and conciseness. The disclosure itself, however, as well as a preferred mode of use, further objects and advantages thereof, will be best understood by reference to the following detailed description of illustrative aspects of the disclosure when read in conjunction with the accompanying drawings, wherein:

FIG. 1 shows one example implementation of a camera/detector mount and camera/detector mount system according to aspects of the disclosure.

FIG. 2 is a view of one of the camera/detector mounts and camera/detector mount system of FIG. 1 according to aspects of the disclosure.

FIG. 3A is a camera/detector housing according to aspects of the disclosure.

FIG. 3B is a second view of a camera/detector housing according to aspects of the disclosure.

FIG. 3C is a diagram view showing example locations of the camera/detector according to aspects of the disclosure.

FIG. 4 is a schematic diagram of an example monitoring and alert system according to aspects of the disclosure.

FIG. 5A is a diagram showing example fields of view and detection zones of a camera/detector system according to aspects of the disclosure.

FIG. 5B is a diagram showing an additional example of fields of view and detection zones of a camera/detector system according to aspects of the disclosure.

FIG. 5C is a diagram right-side view of the example fields of view in FIG. 4B.

FIG. 5D is an example of a camera/detector system according to aspects of the disclosure.

FIG. 6 illustrates an example of an example controller for controlling systems described herein in accordance with aspects of the disclosure.

FIG. 7 illustrates an example of a computer system for controlling systems in accordance with aspects of the present disclosure.

FIG. 8 illustrates a diagram of various examples of networked system components in accordance with aspects of the present disclosure.

### DETAILED DESCRIPTION

The following includes examples of definitions of selected terms employed herein. The definitions include various examples and/or forms of components that fall within the scope of a term and that may be used for implementation. The examples are not intended to be limiting.

The term processor, as used herein, may refer to a device that processes signals and performs general computing and arithmetic functions. Signals processed by the processor may include digital signals, data signals, computer instructions, processor instructions, messages, a bit, a bit stream, or other computing that can be received, transmitted and/or detected. A processor, for example, may include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described herein.

The term bus, as used herein, may refer to an interconnected architecture that is operably coupled so as to transfer data among computer components within a singular or multiple systems. The bus may be or include a memory bus, a memory controller, a peripheral bus, an external bus, a crossbar switch, and/or a local bus, among others. The bus may also be or include a vehicle bus that interconnects components inside a vehicle using protocols such as Controller Area network (CAN), Local Interconnect Network (LIN), among others.

The term memory, as used herein, may include volatile memory and/or nonvolatile memory. Non-volatile memory may include, for example, ROM (read only memory), PROM (programmable read only memory), EPROM (erasable PROM) and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

The term sensor, as used herein, can include any device, component, and/or system that can detect, determine, assess, monitor, measure, quantify, acquire, and/or sense or detect something.

The term operable connection, or signal communication as used herein, may include a coupling by which entities are capable of exchanging information or providing and receiving current, in which signals, physical communications, and/or logical communications may be transmitted and/or received. An operable connection may include a physical interface, a data interface and/or an electrical interface.

The term communication network(s) as used herein can include, without limitation, a wide area network (WAN), a local area network (LAN), the Public Switched Telephone Network (PSTN), a wireless network, a mobile network, a Virtual Private Network (VPN), the Internet, a hardwired communication bus, and/or one or more intranets. The communication network(s) can be implemented as or include one or more wireless networks, whether short range (e.g., a local wireless network built using a Bluetooth or one of the IEEE 802 wireless communication protocols, e.g., 802.11 a/b/g/l, 802.15, 802.16, 802.10, Wi-Fi Protected Access (WPA or WPA2) or long range (e.g., a mobile, cellular, and/or satellite-based wireless network; GSM, TDMA, CDMA, WCDMA networks, or the like). The communication network(s) can include wired communication links and/or wireless communication links. The communication network(s) can include any combination of the above networks and/or other types of networks.

The term vehicle, as used herein, may refer to any moving or moveable vehicle that is capable of carrying one or more human occupants and cargo and is powered by an internal combustion engine and/or an electronic battery and/or any form of energy that may be recharged or refueled. The term “vehicle” may include, but is not limited to: trucks, cars, vans, minivans, sport utility vehicles (SUVs). The term “vehicle” may include self-driving vehicles, hybrid vehicles, and electrical vehicles.

The term system, or vehicle system as used herein, may refer to any electronically or otherwise controlled system on a vehicle or related to vehicle operation and/or driver safety or assistance features and may be operable to perform certain actions on components of the vehicle. For example, a system may provide an interface to allow operation by another system or graphical user interaction. The vehicle systems may include, but are not limited to, vehicle steering or wheel angle monitoring systems, vehicle conditioning systems (e.g., systems that operate a windshield wiper motor, a windshield washer fluid motor or pump, a defroster motor, heating, ventilating, and air conditioning (HVAC) controls), vehicle audio systems, vehicle video systems (i.e., cameras), vehicle safety and/or monitoring systems (e.g., proximity monitoring systems, radar, lidar, global positioning system (GPS) tracking and/or mapping systems) and the like, vehicle assistance systems (e.g., lane assist systems, cross traffic detection systems, parking assist systems, lane-keep assist systems, blind spot monitoring and/or intervention systems, pedestrian warning and/or intervention systems, stopped traffic and/or collision warning and/or intervention systems) or the like.

Throughout the disclosure the term vehicle, hazard, obstacle, or object are used interchangeably however the terms are not intended to be limiting. The aforementioned terms may include anything in a vehicles environment that may potentially require the driver's attention and/or that may pose a hazard to the driver or vehicle and may include but is not limited to stationary objects, other vehicles, pedestrians, animals, road markings or signs, road irregularities, and the like.

Reference throughout this specification to one aspect, an aspect, one example or an example means that a particular feature, structure or characteristic described in connection with the embodiment or example may be a feature included in at least example of the present invention. Thus, appearances of the phrases in one aspect, in an aspect, one example or an example in various places throughout this specification are not necessarily all referring to the same example. Furthermore, the particular features, structures or characteristics may be combined in any suitable combinations and/or sub combinations in one or more embodiments or examples.

Throughout the disclosure, the terms substantially or approximately may be used as a modifier for a geometric relationship between elements or for the shape of an element or component. While the terms substantially or approximately are not limited to a specific variation and may cover any variation that is understood by one of ordinary skill in the art to be an acceptable level of variation, some examples are provided as follows. In one example, the term substantially or approximately may include a variation of less than 10% of the dimension of the object or component. In another example, the term substantially or approximately may include a variation of less than 5% of the object or component. If the term substantially or approximately is used to define the angular relationship of one element to another element, one non-limiting example of the term substantially or approximately may include a variation of 5 degrees or less. These examples are not intended to be limiting and may be increased or decreased based on the understanding of acceptable limits to one of skill in the relevant art.

For purposes of the disclosure, directional terms are expressed generally with relation to a standard frame of reference when the aspects or articles described herein are in an in-use orientation. In some examples, the directional terms are expressed generally with relation to a left-hand coordinate system.

Terms such as a, an, and the, are not intended to refer to only a singular entity, but also include the general class of which a specific example may be used for illustration. The terms a, an, and the, may be used interchangeably with the term at least one. The phrases at least one of and comprises at least one of followed by a list refers to any one of the items in the list and any combination of two or more items in the list. All numerical ranges are inclusive of their endpoints and non-integer values between the endpoints unless otherwise stated.

The terms first, second, third, and fourth, among other numeric values, may be used in this disclosure. It will be understood that, unless otherwise noted, those terms are used in their relative sense only. In particular, certain components may be present in interchangeable and/or identical multiples (e.g., pairs). For these components, the designation of first, second, third, and/or fourth may be applied to the components merely as a matter of convenience in the description.

The present detailed description provides illustrative examples of a vehicle safety and awareness system designed to enhance situational awareness and collision avoidance capabilities. The described technology generally pertains to the field of vehicle safety systems, particularly those incorporating forward and cross-traffic detection technologies using cameras, sensors, and related components mounted on the front end of a vehicle, such as the hood or fender. These systems are applicable to a wide range of vehicles, including heavy-duty trucks, passenger cars, and autonomous vehicles, and aim to improve safety, convenience, and operational efficiency.

The examples and embodiments described herein are provided for illustrative purposes only and are not intended to limit the scope of the subject matter. Certain details, such as standard components or processes well-known to those skilled in the art, may be omitted for clarity and conciseness. Furthermore, the described subject matter encompasses various modifications, rearrangements, and alternative configurations that align with the spirit and scope of the claims. For instance, the described systems may be adapted for retrofit applications or integrated into original equipment manufacturing (OEM) designs, and may include additional features or variations as required by specific use cases or regulatory requirements.

It will be appreciated that for simplicity and clarity of illustration, where appropriate, reference numerals have been repeated among the different figures to indicate elements that share features or function and/or corresponding or analogous elements. In addition, numerous specific details are set forth in order to provide a thorough understanding of the embodiments described herein. However, it will be understood by those of ordinary skill in the art that the aspects described herein can be practiced without all of the specific details described herein and/or with alternative or additional elements that may be known.

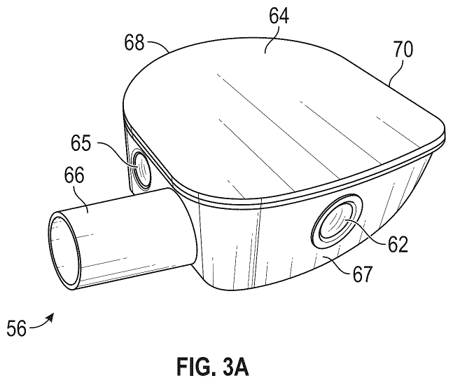

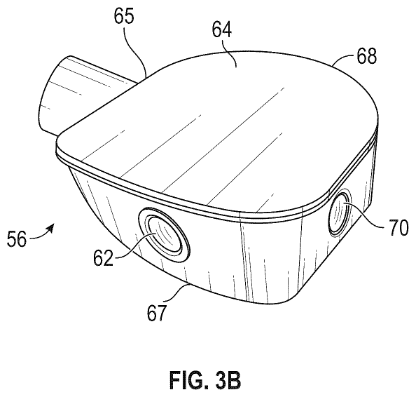

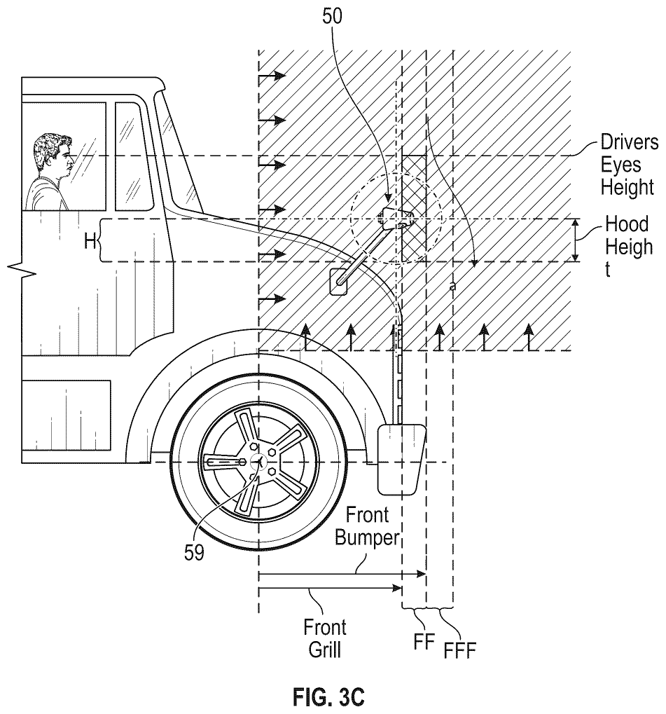

Aspects of this disclosure relate to the cross-detection and forward detection of vehicles and other obstacles or road features using cameras and/or detection devices mounted on a vehicle. In some aspects of the disclosure, the cameras and/or detection devices may be mounted on the hood and/or fender of the vehicle and may be mounted at a height above the hood of the vehicle and/or slightly behind, at, or in front of or ahead of a vehicle front axle or wheel (e.g., wheel 59 for example) and/or ahead of the bumper or front grill of the vehicle. FIG. 3B, shows one non-limiting example of areas in which cameras and/or detection devices may be mounted with respect to a vehicle and additional detailed examples are described in further detail below.

The vehicle safety and awareness system described herein may further be implemented or partially implemented into vehicle mirrors (e.g., hood-mirrors) and/or that may be implemented as separate hood or forward-mounted system. One example of a system includes a camera/detector configuration 50 including a mount bracket 52, a support arm 54, and a camera/detector housing 56. The bracket 52 is configured to mount the camera/detector system 50 to a vehicle 200. For example, the bracket 52 is configured to mount the camera/detector system 50 to a fender 53 or to a hood 55 of the vehicle 58. The bracket 52, for example, may include holes (not shown) to receive bolts, screws, or other fasteners extending through the fender 53 or the hood 55 to attach the bracket 12 to the vehicle 18. Other fastening arrangements may be used to fasten the bracket 12 to the fender 20 or to the hood 22. In some examples, the system according to aspects of this disclosure may instead include a retrofit of either a replacement pod or other housing 56 to replace a mirror and/or may include a pod or other housing 56 that mounts to or otherwise connects to an existing mirror or other system already present on a vehicle 58. The camera/detector system 50 may for example be mounted in front of (i.e., with respect to the forward travel direction of the vehicle) a vehicle front axle or wheels 59.

In one example implementation, the camera/detector system 50 has a profile to achieve low wind resistance when the camera/detector housing 56 is mounted to the fender 53 or to the hood 55 of the vehicle 58. In one example, the housing 56, may be shaped with a rounded portion or taper at the front and may have a flat or slightly curved surfaces on the top and/or bottom to improve flow/aerodynamic qualities and/or to enable laminar airflow.

The support arm 54 may be suitably attached to both the bracket 52 and the camera housing 56 via an attachment portion 66 of the camera/detector housing 56. The support arm 54 may be attached to the bracket 52, for example, by a semi-circular clamp and/or may be permanently connected or bonded thereto. In some examples, the support arm 54 may be configured to pivot or otherwise swing with respect to bracket 52 either as to provide for adjustment and/or to prevent damage in case the support arm 54 and/or the detector housing 56 contacts an obstacle or other feature during use. In further examples, the support arm 54 may have an aerodynamic profile to further improve flow/aerodynamic qualities and/or enable laminar airflow.

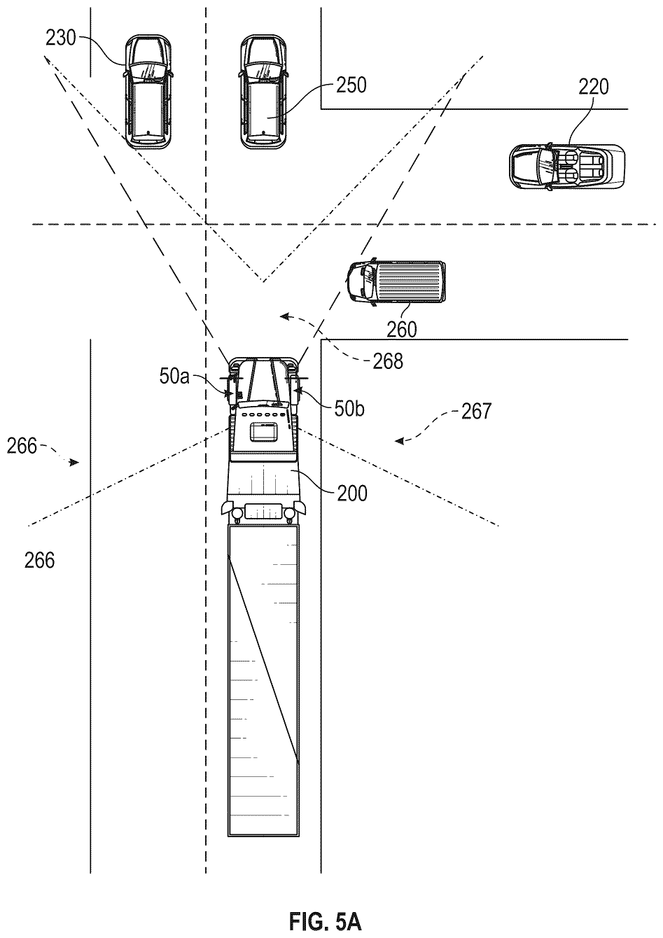

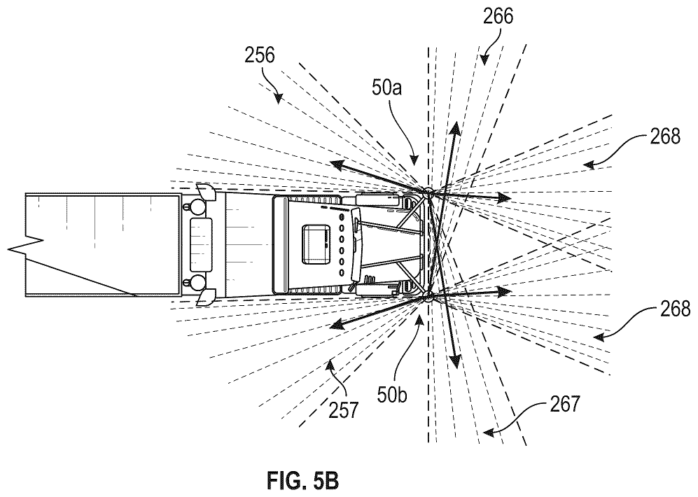

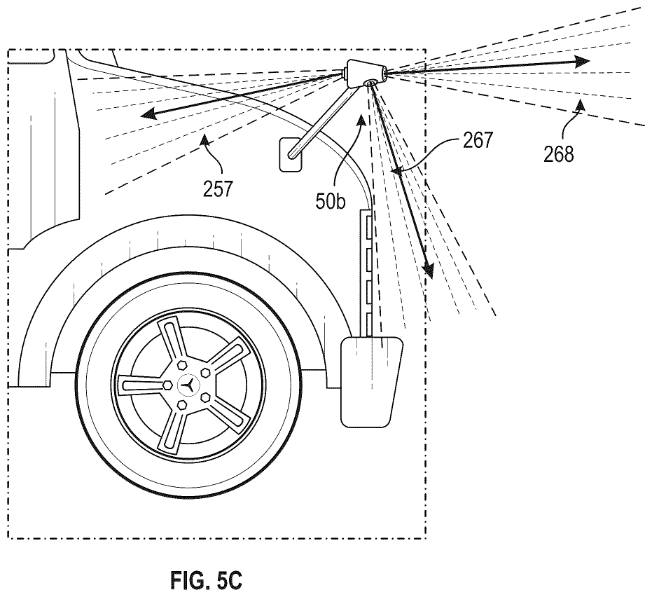

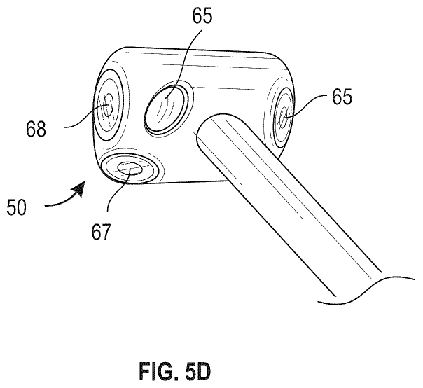

As further shown in FIG. 3A and FIG. 5D, a camera and/or detector housing 56 may have one or more cameras/detectors mounted within the housing part 64 with cameras/windows and/or openings 62, 65, 67 and/or 68 (67 and 68 hidden from view in FIG. 3A, but including any one or more cameras/detectors as shown in FIG. 5D). The cameras and/or detectors may be supported within the housing part 64 and/or may be connected to or on one or more printed circuit boards within the housing part 64 and suitably fastened within the housing part 64 via any known connection method, including but not limited to tabs that are integrally form with the housing part 64. For example, if cameras are implemented into the detector/camera housing, the cameras and/or detectors 62 and/or 65 may be mounted therein with lens is directed toward a transparent window in a wall of the housing as shown in FIGS. 3A and 5D. The transparent windows may be a hole though the side wall of the housing part 64, or the transparent windows may be a transparent plastic or glass material on any wall of the housing part 64. It is noted that while two camera/detectors and/or corresponding windows are shown in FIG. 3A and three camera/detectors and/or corresponding windows are shown in Figured 5D, the camera/detector system according to aspects of the disclosure may utilize any number of camera/detectors including but not limited to one or more rear mounted detectors/cameras 68, one or more side mounted cameras/detectors 70 and/or one or more bottom mounted cameras/detectors 67. Further, the system and housing part 64 may implement a 180-degree, 360-degree, or any known extended field of view camera system.

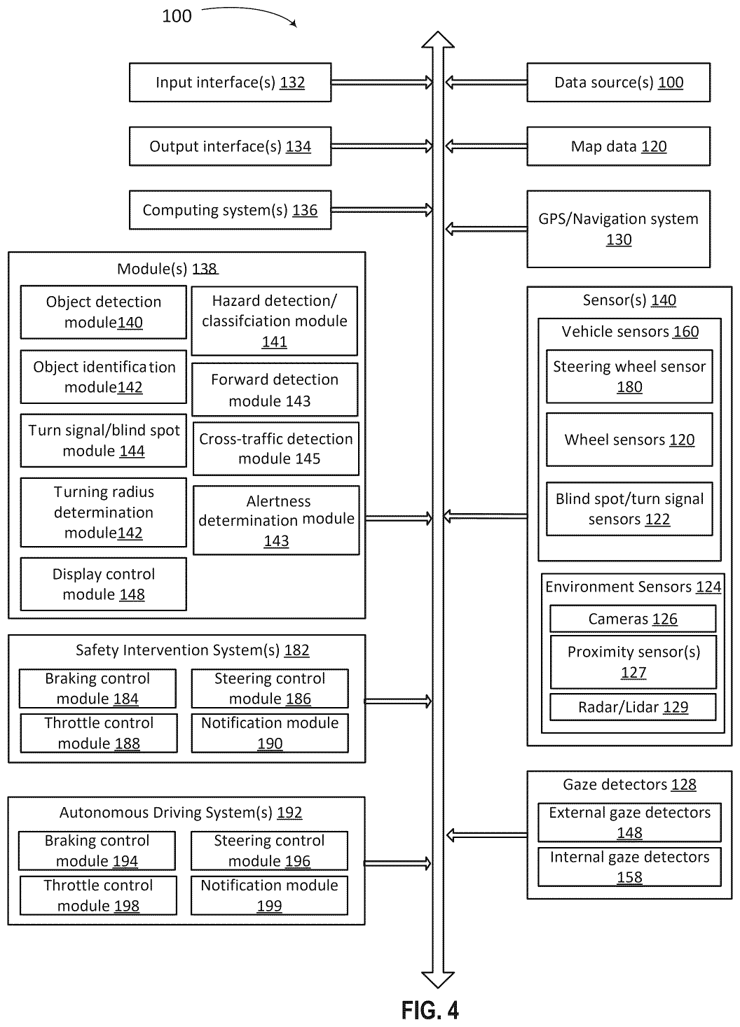

As noted above, in the example including a printed circuit board, the circuit board may include suitable circuitry to process and/or transfer signals from the cameras and/or detectors so that the images detected by the camera can be processed and presented on a display for viewing by the operator of the vehicle and/or for providing signals and/or data for the safety and awareness system 100 of the vehicle (e.g., as described below with respect to FIG. 4).

The higher camera mounting and more-forward mounting position provided by the camera mount (e.g., by mounting the camera/detector system 50 to the hood 55 and/or fender 53 of the vehicle 58 and/or by mounting the camera/detector system 50 slightly behind, at and/or forward of the front axle or wheel 59) may provide a more versatile and usable field of view of the camera/detector system 50). In some examples, as shown in FIG. 3B, the “more-forward mounting position” of the camera/detector system may be located within the “ideal area” noted in FIG. 3B. In another example, the camera/detector system 50 may be mounted to the vehicle so as to be located a horizontal distance FF from the front of the vehicle grille. In some non-limiting examples, distance FF may be Omm to 500 mm. In another example, distance FF may be 50 mm to 300 mm. In another non-limiting example, the camera/detector system 50 may be mounted to the vehicle so as to be located a horizontal distance FFF from the front bumper of the vehicle. In some non-limiting examples, distance FFF may be 0 mm to 500 mm. In another example, distance FF may be 50 mm to 300 mm. . . . In one example, the term “higher camera mounting position” may refer to a camera that is mounted higher than typically would be in a passenger vehicle. In one example, the camera mount may provide mounting for a camera that is a distance HH from the top of the hood of the vehicle. In some examples, the distance HH may be 10 mm to 1000 mm. In another example, the distance HH may be 100 mm to 600 mm. For example, as shown with reference to FIGS. 5A-4C, the camera/detector system 50 on either side of a vehicle 200 such as a truck, in addition to providing blind-spot or rear/side monitoring (e.g., as indicated by zones 256 and 257 in FIGS. 5B and 5C) and as described in further detail below, further provides a cross view/detection in example cross-detection zones 266 and/or 267. In the example shown in FIG. 5A, the camera/detector system 50b may provide detection or a field of view of vehicles 260 and/or 220 shown in FIG. 5A. Likewise, the camera/detector system 50a may provide detection or a field of view of a cross detection zone 266. The aforementioned cross view/detection may be especially advantageous when implemented into large trucks or other vehicles where the driver may typically be seated higher resulting in view that may be improved further away from the vehicle 200 but may have a large number and/or area of blind spots, especially close-to the vehicle body 200.

Further, the camera/detector system 50 may be configured to provide forward detection and/or a forward field of view. In the non-limiting traffic scenario example shown in FIG. 5A, the camera/detector system may have a forward field of view 268 and may be configured to detect or provide a view of vehicles 250 and/or 230 for example. Further, the cameras and/or detectors of any one or both of the camera/detector systems 50 may provide forward obstacle and/or traffic detection and/or avoidance data and/or may provide lane departure warning or road feature and obstacle detections or views. For example, the forward detection feature may warn the driver of a vehicle when their vehicle crosses the road's lane or other markings or when the vehicle system 100 determines that the vehicle is at risk to do so imminently and/or when other vehicles are in a path of trajectory that is indicative of collision with the vehicle 200.

Referring more specifically to FIG. 5B, in an example implementation, the camera/detector system includes a camera pod 50a mounted on a driver's side of the vehicle and a camera pod 50b mounted on a passenger's side of the vehicle. In the example axis system depicted in FIGS. 5A-5C, the pods 50a, 50b are positioned to optimize coverage of the vehicle's surroundings, including forward, lateral, and cross-traffic zones. In one example, camera pod 50a provides a lateral field of view 256 extending along the driver's side of the vehicle; similarly, camera pod 50b provides a lateral field of view 257 extending along the passenger's side. These lateral fields of view 256 and 257 are configured to monitor adjacent lanes and blind-spot areas for potential hazards, such as vehicles or other objects.

The mounting location of the camera pods 50a and 50b is notably more-forward than the windshield, such as on the hood or fender of the vehicle. This more-forward mounting position provides a significant technical advantage by allowing the system to detect objects and hazards earlier than if the pods were mounted at or behind the windshield. By being positioned closer to the front edge of the vehicle, the camera pods 50a and 50b reduce the time required for the system to visually acquire and process information about objects entering the forward and cross-traffic fields of view. This earlier detection enables the system to provide quicker alerts to the vehicle operator and/or to activate safety interventions with reduced latency, which is particularly beneficial in scenarios requiring rapid response, such as sudden pedestrian crossings or abrupt vehicle maneuvers in close proximity to the front of the vehicle.

In addition to the lateral fields of view, the system provides a shared forward field of view 266, which extends ahead of the vehicle in the x-direction. This forward field of view 266 plays an important role in detecting objects, vehicles, or obstacles directly in the vehicle's path, and in some examples is employed to support forward collision detection and avoidance functionalities, lane departure warnings, and road-feature recognition. In one aspect, the forward field of view 266 overlaps with the lateral fields of view 256, 257 to ensure seamless monitoring of the forward and sideward regions. The more-forward mounting of the camera pods 50a and 50b further enhances the effectiveness of the forward field of view 266 by minimizing obstructions from the vehicle body and maximizing the area that can be monitored in real time.

The use of two or more camera pods, such as pods 50a and 50b, provides additional technical advantages by enabling improved depth-perception sensing and detection. When multiple pods are positioned on opposite sides of the vehicle, the system can utilize stereoscopic or binocular vision techniques to more accurately determine the distance to detected objects. This enhanced depth perception allows the system to better judge the relative position and movement of vehicles, pedestrians, or obstacles within the monitored fields of view. Improved depth-perception sensing is particularly beneficial for applications such as collision avoidance, adaptive cruise control, and autonomous driving, where precise distance measurements are important for safe operation and timely intervention.

Furthermore, the camera pods 50a and 50b provide cross-traffic fields of view 267 and 268, respectively. These cross-traffic fields of view extend diagonally across the front corners of the vehicle, intersecting the forward field of view 266. As a result, fields 267 and 268 enable detection of objects or vehicles approaching from oblique angles, such as at intersections or during merging maneuvers, thereby enhancing identification of potential lateral collision risks. The advanced location of the pods 50a and 50b allows the system to detect cross-traffic objects sooner, which is particularly beneficial in urban environments or at busy intersections where rapid decision-making is necessary. The presence of two or more pods also improves the system's ability to triangulate the position and trajectory of cross-traffic objects, further enhancing situational awareness and safety.

Accordingly, the arrangement of the fields of view ensures comprehensive coverage of areas immediately adjacent to the vehicle, the forward path, and cross-traffic zones. This configuration is particularly advantageous for large vehicles, such as trucks, which exhibit significant blind spots and require enhanced situational awareness for safe navigation. The more-forward mounting position of the camera pods 50a and 50b not only improves the breadth of coverage but also contributes to faster reaction and processing times, while the use of multiple pods provides improved depth-perception sensing and detection, thereby increasing the overall safety and effectiveness of the vehicle vision and detection system.

Moreover, integration of camera pods 50a and 50b with the vehicle's safety and awareness system permits real-time analysis of captured images and detection data. In some examples, the system determines a risk level associated with detected objects and provides alerts to the vehicle operator or activates safety interventions as needed. This multi-directional coverage, combined with the technical benefits of the more-forward mounting position and improved depth-perception from multiple pods, contributes to improving the vehicle's ability to detect and respond to potential hazards, which enhances overall safety.

Further, the aforementioned camera/detector system 50 may provide a “birdseye” detection or view showing the areas surrounding the vehicle 200, which may for example further improve safety by showing obstacles that are at or in close proximity to the front and/or sides of the vehicle 200.

Additional examples of implementations and/or mounting systems and/or locations of a camera/detector of the system described herein are described in U.S. Pat. No. 8,896,698, titled “Front End Mounted Video Camera for Vehicle,” and filed on Apr. 30, 2010, the entirety of the aforementioned patent and disclosure is incorporated by reference herein for all purposes. Further features that are usable with aspects of the disclosure are disclosed in US Application No. 2017/0124881, titled “Blind Zone Warning for Semi-trailer,” filed on Oct. 26, 2016, the entirety of the aforementioned application is incorporated herein for all purposes.

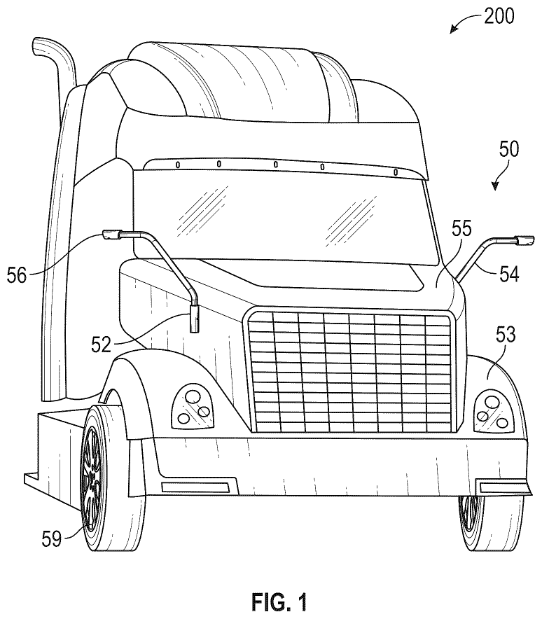

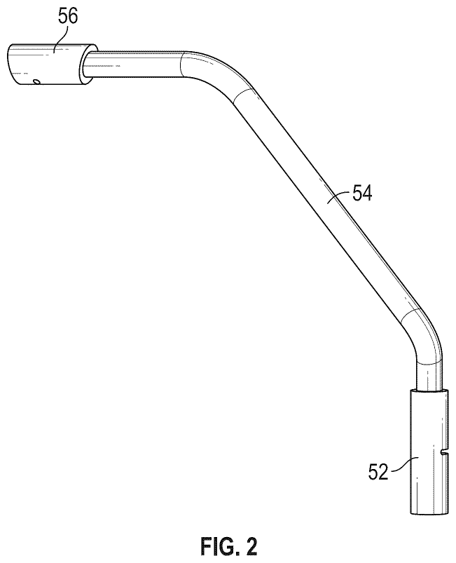

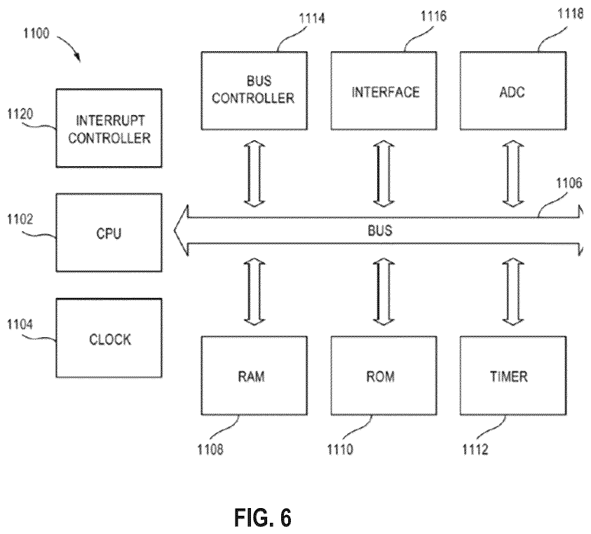

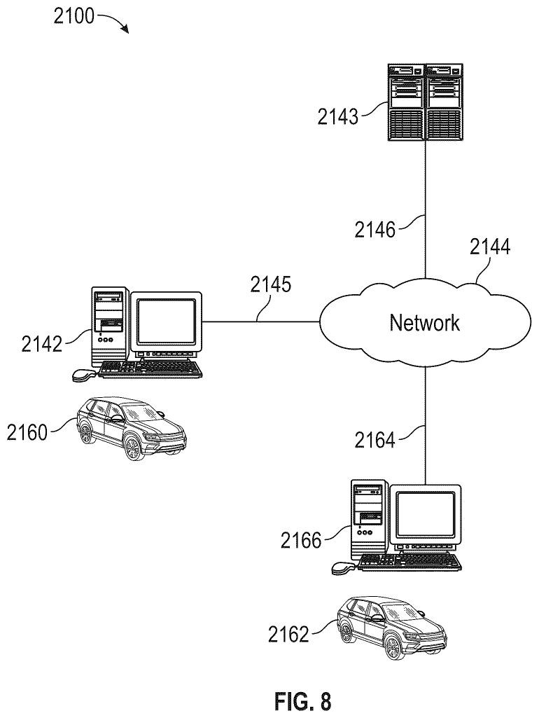

The detector system 50 and/or a vehicle system 100 that includes the camera/detection system can include one or more power sources, one or more data stores 120 including map data 120, a navigation system 130, one or more sensors 140, including vehicle sensors 160 (one or more steering wheel sensors 180, wheel sensors 120, and/or one or more turn signal sensors 122) and environment sensors 124 (which may include any one or combination of cameras 126 that may be analogous with the cameras or other optical detectors described above with respect to FIGS. 1-3). The one or more gaze detectors 128, which may include one or more external gaze detectors and/or one or more internal gaze detectors 158. The system 100 may further include one or more input interface(s) 132, one or more output interface(s) 134, one or more computing and network systems 136 (examples of computing systems are described in further detail with respect to FIGS. 6-8 below), one or more module(s) 138 (including one or more object detection module(s) 140, one or more object identification module(s) 142, one or more turn signal detection module(s) 144, one or more turning radius determination module(s) 146, and/or one or more display control module(s) 148). The display control modules may control any one or more vehicle displays for providing relevant safety and/or alertness data and/or for providing views of the camera/detector systems described above with respect to FIGS. 1-3. In one example, the display control modules may be configured to control one or more transparent displays to provide relevant information. Additional transparent display aspects that may be relevant to this disclosure are described in U.S. application Ser. No. 19/282,530, filed on Jul. 28, 2025 and titled: “Vehicle Transparent Display System and Method.” The entirety of the aforementioned provisional application is incorporated by reference herein for all purposes.

The various elements the camera/detector system 50 and/or the vehicle system 100 can be communicatively linked to one another or one or more other element(s) through one or more communication networks. The term communicatively linked, as used herein, can include direct or indirect connections through a communication channel, bus, pathway, or another component or system. The term communication network, as used herein, means one or more components designed to transmit and/or receive information from one source to another. The vehicle system 100 can include and/or execute suitable software, which enable the various elements to communication with each other through the communication network and perform the functions disclosed herein. Additional examples of computing and network systems are described in further detail below with respect to FIGS. 6-8).

The camera/detector system 50 and/or the vehicle system 100 can include one or more power sources as noted above. The power source(s) can be any power source capable of and/or configured to provide sufficient power to the camera/detector system 50 and/or the vehicle system 100 and the elements thereof. For example, the power source(s) can include one or more batteries, one or more fuel cells, one or more generators, one or more alternators, one or more solar cells, and combinations thereof. In some arrangements, the power source(s) can be one or more power sources of the vehicle.

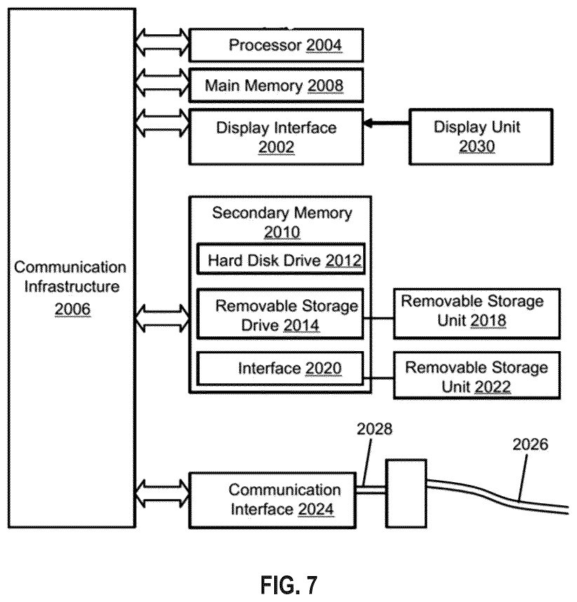

The vehicle system 100 can include one or more data stores, which may include map data 120, as noted above. The data store(s) can include volatile and/or non-volatile memory. The data store(s) can be a component of the computing systems 136, or the data store(s) can be operatively connected to the processor(s) the computing systems 136 and/or processors associated with the computing systems 136. The data store(s) can be configured to store map data 120, and/or any other data and/or information from one or more elements of the system 100. Additional examples of computing systems and controllers are described below with respect to FIGS. 6 and 7.

The map data 120 can include maps of one or more geographic areas. In some instances, the map data 120 can include information or data on roads, traffic control devices, road markings, streetlights, structures, features, and/or landmarks in the one or more geographic areas. The map data 120 can include information about ramps, merging points between the ramps and the main lanes, and geo-fences surrounding the merging points. The map data 120 can be in any suitable form. In some instances, the map data 120 can include aerial views of an area. In some instances, the map data 120 can include ground views of an area, including 360-degree ground views. The map data 120 can include measurements, dimensions, distances, positions, coordinates, and/or information for one or more items included in the map data 120 and/or relative to other items included in the map data 120. The map data 120 can include a digital map with information about road geometry. In one or more arrangements, the map data 120 can include information about the ground, terrain, roads, surfaces, and/or other features of one or more geographic areas. The map data 120 can include elevation data in the one or more geographic areas. The map data 120 can define one or more ground surfaces, which can include paved roads, unpaved roads, land, and other things that define a ground surface. The map data 120 can be high quality and/or highly detailed.

As noted above, the system 100 can include a navigation system 130. The navigation system 130 can include one or more mechanisms, devices, elements, components, systems, applications and/or combinations thereof, now known or later developed, configured to determine the geographic location of the vehicle and/or to determine a travel route for the vehicle and/or other vehicles that could affect operation of the vehicle. The navigation system 130 can include one or more mapping applications to determine a travel route for the vehicle. The navigation system 130 can include a global positioning system (GPS), a local positioning system, or a geolocation system. In one or more arrangements, the navigation system 130 can include a GPS, a local positioning system or a geolocation system. The navigation system 130 can be implemented with any one of a number of satellite positioning systems, now known or later developed. Further, the navigation system 130 can use Transmission Control Protocol (TCP) and/or a Geographic information system (GIS) and location services. The navigation system 130 may include a transceiver configured to estimate a position of the vehicle with respect to the Earth. For example, navigation system 130 can include a GPS transceiver to determine the vehicle's latitude, longitude and/or altitude. The navigation system 130 can use other systems (e.g. laser-based localization systems, inertial-aided GPS, and/or camera-based localization) to determine the location of the vehicle.

As noted above, the system 100 can include one or more sensors 140. The sensor(s) 140 can detect, determine, assess, monitor, measure, quantify, acquire, and/or sense in real-time. The term real-time, as used herein, can mean a level of processing responsiveness that a user or system senses as sufficiently immediate for a particular process or determination to be made, or that enables the processor to keep up with some external process. The sensor(s) 140 can be operatively connected to the computing systems(s) 136 including processors or data stores therein, the data sources 100, and/or any other elements of the system 100. In arrangements in which the system 100 includes a plurality of sensors 140, the sensors 140 can work independently from each other. Alternatively, two or more of the sensors 140 can work in combination with each other. In this example, the two or more sensors 140 can form a sensor network. One or more of the sensors may be implemented into the detector housing 56 and/or the camera/detector system 50. Further, some of the sensors may be located at other locations on the vehicle and may communicate or otherwise work in conjunction with the cameras and/or detectors in the detector housing 56.

The sensor(s) 140 can include any suitable type of sensor for completing operations describe herein. The sensor(s) 140 can include one or more vehicle sensors 160, as noted above. The vehicle sensor(s) 160 can detect, determine, assess, monitor, measure, quantify, and/or sense information about the vehicle itself (e.g., position, orientation, speed, etc.). The vehicle sensor(s) 160 can include the steering wheel sensor(s) 180, the wheel sensors 120, and/or the blind spot/turn signal sensor(s) 122. The steering wheel sensor(s) 180 can be configured to collect data and/or information about a steering wheel of the vehicle. For example, the steering wheel sensor(s) 180 can be configured to collect data and/or information about the position of the steering wheel, a steering wheel angle, how much the steering wheel has turned in a specific amount of time, and/or how fast the steering wheel is being turned.

In some arrangements, the steering wheel sensor(s) 180 can include one or more rotary position sensors. In some instances, the wheel sensors 120 can be configured to collect data and/or information about the wheels of the vehicle. For example, the wheel sensors 120 can be configured to collect data and/or information about the speed the wheels are spinning, whether the wheels are being turned, and the angle at which the wheels are being turned. The turn signal and/or blind spot sensor(s) 122 can be configured to determine whether a turn signal of the vehicle is activated or deactivated. In some arrangements, the vehicle sensors 160 can be part of other systems typical of vehicles, for example, parking assist systems, lane keeping assist systems, adaptive cruise control systems, etc. The sensor(s) 140 can also include one or more environment sensors 124.

The environment sensor(s) 124 can be configured to detect, determine, assess, monitor, measure, quantify, acquire, and/or sense driving environment data. The term “driving environment data,” as used herein, includes any data or information about the external environment in which the vehicle (e.g., vehicle 200 in FIGS. 3B and 5A-5C) is located or one or more portions thereof. The environment sensor(s) 124 can include one or more cameras 126. The camera(s) 126 can be located on the vehicle for example, positioned along one or both sides of the vehicle on the exterior of the vehicle. In some arrangements, the camera(s) 126 can be located in or on an exterior side view mirror of the vehicle or in a location where a side view mirror or mirrors would normally be located. In other examples, the camera(s) 126 could be located on an exterior of the vehicle at a location suitable to show a view that would normally be viewable by side view mirrors and/or rear-view mirrors. Further, the camera(s) 126 could be arranged to provide a top-down or underside view of the vehicle. In other arrangements, the camera(s) 126 can be located in any other suitable location on the vehicle. One or more of the sensors may be implemented into the detector housing 56 and/or the camera/detector system 50. Further, some of the sensors may be located at other locations on the vehicle and may communicate or otherwise work in conjunction with the cameras and/or detectors in the detector housing 56. For example, the blind spot sensor(s) 122 may be implemented into the detector housing 56 and may communicate with or outputs from the sensor(s) 122 may otherwise be used with the signals provided from the steering wheel sensor(s) 180 and/or the wheel sensors 120.

The camera(s) 126 can be configured to acquire visual data of a portion of the exterior environment of the vehicle (e.g., vehicle 200 in FIG. 5A). Specifically, the camera(s) 126 can be configured to acquire visual data of at least one or more of blind spots (e.g., at a side of the vehicle proximal to the passenger compartment and/or the trailer) and/or may acquire visual data from cross detection zones 266 and/or 267 shown in FIGS. 5A, 5B and/or 5C for example and/or may acquire visual data from the front of the vehicle 268 and/or any other view of the exterior environment of the vehicle. For example, the vehicle can include one or more first cameras mounted on a camera/detector system 50a (e.g., which may share features with or may be analogous with camera/detector system 50 described above) on the exterior of the vehicle 200 on the driver's side, which can be configured to acquire visual data about any one or combination of a rear or side blind spot, cross information in cross zone 266, and/or forward information from forward zone 268 on the driver's side of the vehicle 200. The vehicle 100 can include one or more second cameras mounted on a camera/detector system 50b (e.g., which may share features with or may be analogous with camera/detector system 50 described above) on the exterior of the vehicle 200 on the passenger side, which can be configured to acquire visual data about any one or combination of a rear or side blind spot, cross information in cross zone 267, and/or forward information from forward zone 268 on the driver's side of the vehicle 200. As shown in FIGS. 5A, 5B, and/or 5C, the driver's side of the vehicle 200 is the left side of the vehicle, and the passenger's side is the right side of the vehicle 200. However, it will be understood that in some arrangements, the driver's side of the vehicle 200 can be the right side of the vehicle, and the passenger's can be the left side thereof. The visual data collected by the camera(s) 126 can include video and/or still images of the blind spot(s), cross information, and/or forward information. The visual data can be acquired continuously in real-time. The camera(s) 126 can be operatively connected to the computing systems 136. The camera(s) 126 can be any suitable camera and/or other imaging device, for example, one or more wide-angle camera(s), one or more fish-eye camera(s), one or more infrared camera(s), one or more thermal camera(s), and/or one or more camera(s) modified with a lens of a different focal length. In some arrangements, the camera(s) 126 can be part of a perception system typical of vehicles. Specifically, the camera(s) 126 can be included in the vehicle 200 as part of a panoramic view monitor (PVM) for adding driver visibility of the vehicle 200 and the exterior environment of the vehicle 200.

The camera/detection system 50 may further implement one or more radar and/or lidar sensors 129 either as part of/within the detector housing 56 and/or may communicate or otherwise provide signals in conjunction with the radar and/or lidar sensors 129. The radar and/or lidar sensors 129 may provide signals related to the cross zones 266 and/or 267 and/or the front zone 268 of the vehicle. In some examples, the radar and/or lidar sensors may be used instead of the aforementioned cameras. In another example, the radar and/or lidar sensors may be used in conjunction with the aforementioned cameras.

The system 100 can include one or more gaze detectors 128, which may include one or more internal gaze detectors 132 and one or more external gaze detectors 131, which in some examples may utilize any one or combination of the cameras 126 described above. The internal gaze detectors 132 can be located in the passenger compartment of the vehicle 200. The gaze detectors 128 can be operatively connected to the computing systems or processors therein. The internal gaze detector 132 can be configured to detect one or more characteristics and/or movements of the driver. For example, the internal gaze detector can detect movements of the driver's head and/or movements of the driver's eyes. Using this information, the internal gaze detectors can determine the line of sight of the driver, for example, the direction in which the driver is looking, and/or the internal gaze can determine if the driver moves his or her head to look toward or away from any one or combination of a blind spot, the cross zones 266 and/or 267 and/or the forward zone 268. The gaze detectors can include any suitable technology, now known or later developed, configured to perform these processes. In some arrangements, the internal gaze detector(s) 128 can be part of driver monitoring systems typical of vehicles, for example, fatigue detection systems, security systems, etc.

The external gaze detectors 131 can be operatively connected to the computing systems or processors therein. The external gaze detector 132 can be configured to detect one or more characteristics and/or movements of the drivers of surrounding vehicles (e.g., vehicles 220, 230, 250, and/or 260) and/or pedestrians, cyclists, or motorcycle drivers. For example, the external gaze detector 131 can detect movements of driver/operators/pedestrian's head and/or movements of their eyes. Using this information, the external gaze detectors can determine the line of sight of external driver/operators/pedestrians, for example, the direction in which the external drivers/operators/pedestrians are looking to help determine their level of situational awareness and/or to determine if they are aware of the presence or location of the vehicle 200. The gaze detectors can include any suitable technology, now known or later developed, configured to perform these processes. In some arrangements, the external gaze detector(s) 131 can communicate the internal gaze detectors and/or sensors of surrounding vehicles (i.e., vehicles 220, 230, 250 and/or 260) and their driver monitoring systems typical of vehicles, for example, fatigue detection systems, security systems, etc.

The vehicle system 100 may further include both a safety intervention system 182 and an autonomous driving system 192. The safety intervention system 182 is designed communicate with the monitor vehicle and environmental conditions in real time and to execute active safety measures that assist or override the operator to prevent or mitigate hazardous situations. The autonomous driving system 192 is configured to control vehicle dynamics and navigation with minimal or no human input, utilizing sensor data and processing modules to enable semi-autonomous or fully autonomous operation.

In further detail, the safety intervention system 182 is configured to actively monitor the vehicle's environment and internal state, and to execute real-time interventions to enhance safety and prevent collisions. The braking control module 184 may, for example, automatically apply the vehicle's brakes when an imminent collision is detected, such as when an object is identified in the forward path and/or cross path and the risk level exceeds a predetermined threshold. In another non-limiting example, the braking control module 184 may modulate brake pressure to assist with emergency stopping or adaptive cruise control functions.

The steering control module 186 may provide corrective steering inputs to avoid obstacles, maintain lane position, or assist with evasive maneuvers. For instance, if the object detection module 140 identifies a hazard in the vehicle's trajectory, the steering control module 186 may execute a lane departure avoidance maneuver or steer the vehicle away from the detected hazard. In another example, the steering control module 186 may work in conjunction with the turning radius determination module 146 to optimize steering during tight turns or when navigating around obstacles.

The throttle control module 188 may reduce engine power or modulate acceleration in response to detected risks. For example, if the forward detection module 143 determines that the vehicle is approaching stopped traffic or a stationary object, the throttle control module 188 may decrease throttle input to slow the vehicle. In another example, the throttle control module 188 may work with adaptive cruise control systems to maintain a safe following distance.

The notification module 190 is configured to provide alerts to the vehicle operator through the output interface(s) 134. Non-limiting examples include visual warnings on a dashboard display, audible alerts such as beeps or spoken messages, and haptic feedback such as steering wheel or seat vibrations. The notification module 190 may also escalate the alert level based on the severity of the detected risk, for instance, providing a flashing visual indicator and a loud audible alarm when a collision is imminent.

The autonomous driving system 192 is designed to enable semi-autonomous or fully autonomous operation of the vehicle by integrating sensor data, mapdata 120, and navigation inputs to control vehicle dynamics without direct operator intervention. The braking control module 194 may autonomously apply or modulate the brakes to maintain safe speeds, stop at traffic signals, or respond to detected obstacles. For example, the braking control module 194 may bring the vehicle to a complete stop at a red light or in response to a pedestrian crossing.

The steering control module 196 may autonomously guide the vehicle along a planned route, maintain lane centering, execute lane changes, or perform complex maneuvers such as parking. In a non-limiting example, the steering control module 196 may follow GPS/Navigation system 130 instructions to navigate through intersections or merge onto highways.

The throttle control module 198 may autonomously control acceleration and deceleration to optimize fuel efficiency, maintain safe distances from other vehicles, and comply with speed limits. For instance, the throttle control module 198 may accelerate smoothly from a stop or reduce speed in response to changing traffic conditions.

The notification module 199 may provide status updates, route information, or warnings to passengers or remote operators. Non-limiting examples include displaying autonomous mode status, route progress, or system health information on a vehicle display, as well as issuing alerts when manual intervention is required or when the system detects a condition outside the operational design domain.

These modules within the safety intervention system 182 and autonomous driving system 192 may operate independently or in coordination, leveraging real-time data from the sensor(s) 140 and module(s) 138 to ensure optimal safety and performance in both manual and autonomous driving scenarios.

In some examples any one or more of the detectors and/or cameras may provide signals to the system 100 to provide information related to the cross-traffic zones (e.g., zones 266 and/or 267 shown in FIGS. 5A, 5B and/or 5C) and/or may provide information related to the environment in front of the vehicle 200, for example in zone 268. If a vehicle or other object is located in proximity of the front of the vehicle in zone 268, the system may provide a warning to the vehicle operator. The warning may be any one or combination of a visual representation, an audible tone, a vibration, and/or a camera or live-view of the relevant vehicle or object. In some examples, the system 100 may first determine the risk level of the detected or viewed vehicle or object and may provide the warning based on the determined risk level. For example, if an internal vehicle display is utilized, module(s) 148 may provide a photographic or video image of the vehicle or object with an overlay or other indicator (e.g., highlights, color-coded halo or other visual indicators) based on the risk level and based on if the detected vehicle or object requires the driver's attention. Similarly, the aforementioned audible warning or tactile warning (e.g., a vibration) may be increased of altered based on the risk level (e.g., the audible warnings and/or vibrations may increase in frequency or intensity).

The system may further provide information related data further ahead of the vehicle than the aforementioned example of forward zone 268. For example, while in the previous example, a vehicle or object in close proximity to the front of the vehicle 200 may be hidden from view from a driver due to the hood and/or height of the vehicle 200, the system 100 may further detect or otherwise provide information related to vehicles or other objects that may be within the drivers field of view but may still require the drives attention. For example, the system 100 and/or the sensors/detector system 50 may provide forward collision, lane assist, street sign detection and/or dynamic cruise control data. The warning may be any one or combination of a visual representation, an audible tone, a vibration, and/or a camera or live-view of the relevant vehicle or object. Similar to the features above, the system 100 may first determine the risk level of the detected or viewed vehicle or object and may provide the warning based on the determined risk level. For example, if an internal vehicle display is utilized, module(s) 148 may provide a photographic or video image of the vehicle or object with an overlay or other indicator (e.g., highlights, color-coded halo or other visual indicators) based on the risk level and based on if the detected vehicle or object requires the driver's attention. Similarly, the aforementioned audible warning or tactile warning (e.g., a vibration) may be increased of altered based on the risk level (e.g., the audible warnings and/or vibrations may increase in frequency or intensity).

As noted above, the system may further provide information related data in cross zones 266 and/or 267. The system may provide information related to vehicles or other obstacles that are close to the vehicle 200 (and thus may not be in the field of view of the driver) and/or may provide information related to vehicles or obstacles that may be within the driver's field of view but may otherwise require a driver's attention. For example, the system 100 and/or the sensors/detector system 50 may provide side/cross collision, obstacle detection and/or street sign detection. The warning may be any one or combination of a visual representation, an audible tone, a vibration, and/or a camera or live-view of the relevant vehicle or object. In some examples, the system 100 may first determine the risk level of the detected or viewed vehicle or object and may provide the warning based on the determined risk level. For example, if an internal vehicle display is utilized, module(s) 148 may provide a photographic or video image of the vehicle or object with an overlay or other indicator (e.g., highlights, color-coded halo or other visual indicators) based on the risk level and based on if the detected vehicle or object requires the driver's attention. Similarly, the aforementioned audible warning or tactile warning (e.g., a vibration) may be increased of altered based on the risk level (e.g., the audible warnings and/or vibrations may increase in frequency or intensity).

It is noted that while specific examples of operations are described above, one of skill in the art would understand implementations of the system based on the description herein as applicable to other obstacles and scenarios. For example, similar features may be implemented for pedestrians, animals, and/or other potential hazards or environmental features encountered during use of the vehicle 200.

The aspects described above may be particularly advantageous when driving at night and/or in adverse conditions, when it may be difficult for a driver to see and/or glare from vehicle headlights may otherwise be distracting or may hide or reduce the visibility of vehicles or other obstacles.

As noted above, as part of or incorporating various features of the vehicle 200, vehicle system 100 and/or the camera/detector system 50 described herein, one or more microcontrollers may be implemented for carrying out various operations in accordance with aspects of the present invention. Various components of such a controller 1100 are shown in representative block diagram form in FIG. 6. In FIG. 6, the controller 1100 includes a CPU 1102, clock 1104, RAM 1108, ROM 1110, a timer 1112, a BUS controller 1114, an interface 1116, and an analog-to-digital converter (ADC) 1118 interconnected via a BUS 1106.

The CPU 1102 may be implemented as one or more single core or multi-core processors, and receive signals from an interrupt controller 1120 and a clock 1104. The clock 1104 may set the operating frequency of the entire microcontroller 1100 and may include one or more crystal oscillators having predetermined frequencies. Alternatively, the clock 1104 may receive an external clock signal. The interrupt controller 1120 may also send interrupt signals to the CPU, to suspend CPU operations. The interrupt controller 1120 may transmit an interrupt signal to the CPU when an event requires immediate CPU attention.

The RAM 1108 may include one or more Static Random Access Memory (SRAM), Dynamic Random Access Memory (DRAM), Synchronous Dynamic Random Access Memory (SDRAM), Double Data-Rate Random Access Memory (DDR SDRAM), or other suitable volatile memory. The Read-only Memory (ROM) 1110 may include one or more Programmable Read-only Memory (PROM), Erasable Programmable Read-only Memory (EPROM), Electronically Erasable Programmable Read-only memory (EEPROM), flash memory, or other types of non-volatile memory.

The timer 1112 may keep time and/or calculate the amount of time between events occurring within the controller 1100, count the number of events, and/or generate baud rate for communication transfer. The BUS controller 1114 may prioritize BUS usage within the controller 1100. The ADC 1118 may allow the controller 1100 to send out pulses to signal other devices.

The interface 1116 may comprise an input/output device that allows the controller 1100 to exchange information with other devices. In some implementations, the interface 1116 may include one or more of a parallel port, a serial port, or other computer interfaces.

In addition, aspects of the present disclosures may be implemented using hardware, software, or a combination thereof and may be implemented in one or more computer systems or other processing systems. In an aspect of the present disclosures, features are directed toward one or more computer systems capable of carrying out the functionality described herein. An example of such the computer system 2000 is shown in FIG. 7.

The computer system 2000 may include one or more processors, such as processor 2004. The processor 2004 may be connected to a communication infrastructure 2006 (e.g., a communications bus, cross-over bar, or network). Various software aspects are described in terms of this example computer system. After reading this description, it will become apparent to a person skilled in the relevant art(s) how to implement aspects of the disclosures using other computer systems and/or architectures.

The computer system 2000 may include a display interface 2002 that forwards graphics, text, and other data from the communication infrastructure 2006 (or from a frame buffer not shown) for display on a display unit 2030. Computer system 2000 also includes a main memory 2008, preferably random access memory (RAM), and may also include a secondary memory 2010. The secondary memory 2010 may include, for example, a hard disk drive 2012, and/or a removable storage drive 2014, representing a floppy disk drive, a magnetic tape drive, an optical disk drive, a universal serial bus (USB) flash drive, etc. The removable storage drive 2014 reads from and/or writes to a removable storage unit 2018 in a well-known manner. Removable storage unit 2018 represents a floppy disk, magnetic tape, optical disk, USB flash drive etc., which is read by and written to removable storage drive 2014. As will be appreciated, the removable storage unit 2018 includes a computer usable storage medium having stored therein computer software and/or data.

Alternative aspects of the present disclosure may include secondary memory 2010 and may include other similar devices for allowing computer programs or other instructions to be loaded into computer system 2000. Such devices may include, for example, a removable storage unit 2022 and an interface 2020. Examples of such may include a program cartridge and cartridge interface (such as that found in video game devices), a removable memory chip (such as an erasable programmable read only memory (EPROM), or programmable read only memory (PROM)) and associated socket, and other removable storage units 2022 and interfaces 2020, which allow software and data to be transferred from the removable storage unit 2022 to computer system 2000.

Computer system 2000 may also include a communications interface 2024. Communications interface 2024 allows software and data to be transferred between computer system 2000 and external devices. Examples of communications interface 2024 may include a modem, a network interface (such as an Ethernet card), a communications port, a Personal Computer Memory Card International Association (PCMCIA) slot and card, etc. Software and data transferred via communications interface 2024 are in the form of signals 2028, which may be electronic, electromagnetic, optical or other signals capable of being received by communications interface 2024. These signals 2028 are provided to communications interface 2024 via a communications path (e.g., channel) 2026. This path 2026 carries signals 2028 and may be implemented using wire or cable, fiber optics, a telephone line, a cellular link, an RF link and/or other communications channels. In this document, the terms “computer program medium” and “computer usable medium” are used to refer generally to media such as a removable storage drive 2018, a hard disk installed in hard disk drive 2012, and signals 2028. These computer program products provide software to the computer system 2000. Aspects of the present disclosures are directed to such computer program products.

Computer programs (also referred to as computer control logic) are stored in main memory 2008 and/or secondary memory 2010. Computer programs may also be received via communications interface 2024. Such computer programs, when executed, enable the computer system 2000 to perform the features in accordance with aspects of the present disclosures, as discussed herein. In particular, the computer programs, when executed, enable the processor 2004 to perform the features in accordance with aspects of the present disclosures. Accordingly, such computer programs represent controllers of the computer system 2000.

In an aspect of the present disclosures where the method is implemented using software, the software may be stored in a computer program product and loaded into computer system 2000 using removable storage drive 2014, hard drive 2012, or communications interface 2020. The control logic (software), when executed by the processor 2004, causes the processor 2004 to perform the functions described herein. In another aspect of the present disclosures, the system is implemented primarily in hardware using, for example, hardware components, such as application specific integrated circuits (ASICs). Implementation of the hardware state machine so as to perform the functions described herein will be apparent to persons skilled in the relevant art(s).

FIG. 7 is a block diagram of various example communication system components usable in accordance with an aspects of the present disclosure. The communication system 2100 includes one or more accessors 2160, 2162 (which may for example comprise any of the aforementioned systems and features) and one or more terminals 2142, 2166. In one aspect, data for use in accordance with aspects of the present disclosure is, for example, input and/or accessed by accessors 2160, 2162 via terminals 2142, 2166, such as personal computers (PCs), minicomputers, mainframe computers, microcomputers, telephonic devices, or wireless devices, such as personal digital assistants (“PDAs”) or a hand-held wireless devices coupled to a server 2143, such as a PC, minicomputer, mainframe computer, microcomputer, or other device having a processor and a repository for data and/or connection to a repository for data, via, for example, a network 2144, such as the Internet or an intranet, and couplings 2145, 2146, 2164. The couplings 2145, 2146, 2164 include, for example, wired, wireless, or fiberoptic links. In another example variation, the method and system in accordance with aspects of the present disclosure operate in a stand-alone environment, such as on a single terminal.

Additional aspects that are usable in combination with aspects of this disclosure are described in US Patent Publication No. 2022/0396205, titled “Dual-sided Display for a Vehicle,” U.S. Pat. No. 11,467,401, titled “Display and Light Blocking Screens,” US Patent Application No. 2015/0353014, titled “Devices, Systems and Method for Identifying Potentially Dangerous Oncoming Cars,” European Publication EP1407931, titled “Process and System for Assisting a Driver,” US Patent Application No. 2017/0124407, titled “Predicting Vehicle Movements Based on Driver Body Language,” U.S. Pat. No. 9,767,693, titled “Transparent Display Apparatus for Displaying Information of Danger Element, and Method Thereof” and European Publication EP 2168815, titled “Method and Device for Detecting Possibly Colliding Objects in a Blind Spot Area.” All of the listed patents and publications listed above are hereby incorporated herein in their entirety for all purposes.

Aspects of the disclosure are further described in the clauses that follow:

Clause 1. A vehicle vision and detection system comprising: a bracket configured to be secured to a hood or fender of a vehicle; a support arm operably connected to the bracket; a housing; a plurality of cameras and/or detectors disposed within the housing and arranged to capture image or detection data corresponding to a forward field of view and first and second cross-traffic fields of view on opposite sides of the vehicle; one or more processors operably connected to the plurality of cameras and/or detectors and configured to: receive image or detection data from the plurality of cameras and/or detectors corresponding to the first and second cross-traffic fields of view; analyze the received image or detection data to detect objects within the first and second cross-traffic fields of view; determine a risk level associated with each detected object based on the analyzed image or detection data; and cause an output interface to provide an alert to a vehicle operator based on the determined risk level of a detected object.

Clause 2. The vehicle vision and detection system of clause 1, where the one or more processors are further operatively connected to the plurality of cameras and/or detectors to receive image or detection data corresponding to the forward field of view; and analyze the received image or detection data to detect objects within the forward field of view to determine the risk level associated with each detected object.

Clause 3. The vehicle vision and detection system of clause 1, wherein the support arm extends forward of a front grille of the vehicle, and the housing is attached to the support arm and positioned above the hood or fender and forward of a front axle of the vehicle.

Clause 4. The vehicle vision and detection system of clause 2, wherein the housing comprises transparent windows through which the plurality of cameras and/or detectors capture image or detection data.

Clause 5. The vehicle vision and detection system of clause 3, wherein at least one of the cameras comprises a wide-angle camera having a field of view of at least 120 degrees.

Clause 6. The vehicle vision and detection system of clause 1, wherein the plurality of cameras and/or detectors further comprises at least one radar sensor or at least one LiDAR sensor arranged to capture detection data corresponding to the first and second cross-traffic fields of view.

Clause 7. The vehicle vision and detection system of clause 1, wherein the support arm has a pivotable connection to the bracket, the pivotable connection configured to allow the housing to swing away from an obstacle upon impact.

Clause 8. The vehicle vision and detection system of clause 1, wherein the one or more processors are further configured to integrate map data and navigation data stored in a data store to refine the determined risk levels based on road geometry and traffic conditions.

Clause 9. The vehicle vision and detection system of clause 8, wherein the one or more processors are further configured to predict a potential collision trajectory of a detected object moving laterally across one of the first and second cross-traffic fields of view and to increase the associated risk level when the predicted trajectory intersects a forward path of the vehicle.

Clause 10. The vehicle vision and detection system of clause 1, wherein the output interface comprises at least one of a transparent head-up display, an audible output device, and a haptic actuator configured to provide alerts to the vehicle operator based on the determined risk level.

Clause 11. A non-transitory computer-readable medium storing instructions that, when executed by one or more processors of a vehicle vision and detection system comprising a bracket configured to be secured to a hood or fender of a vehicle, a support arm operably connected to the bracket, and a housing, and a plurality of cameras and/or detectors disposed within the housing and arranged to capture image or detection data corresponding to a forward field of view and first and second cross-traffic fields of view on opposite sides of the vehicle, cause the one or more processors to perform operations comprising: receiving image or detection data from the plurality of cameras and/or detectors corresponding to the forward field of view and the first and second cross-traffic fields of view; analyzing the received image or detection data to detect objects within the forward field of view and the first and second cross-traffic fields of view; determining a risk level associated with each detected object based on the analyzed image or detection data; and causing an output interface to provide an alert to a vehicle operator based on the determined risk level of a detected object.

Clause 12. The non-transitory computer-readable medium of clause 11, wherein the support arm extends forward of a front grill of the vehicle, the housing is attached to the support arm and positioned above the hood or fender and forward of a front axle of the vehicle.

Clause 13. The non-transitory computer-readable medium of clause 11, wherein the plurality of cameras and/or detectors comprises at least one radar sensor or at least one LiDAR sensor arranged to capture detection data for the forward field of view and at least one of the first and second cross-traffic fields of view.

Clause 14. The non-transitory computer-readable medium of clause 11, wherein the instructions further cause the one or more processors to integrate map data and navigation data stored in a data store to refine the determined risk levels based on road geometry and traffic conditions.

Clause 15. The non-transitory computer-readable medium of clause 11, wherein the output interface comprises at least one of a transparent head-up display, a vehicle dashboard display, an audible output device, and a haptic actuator configured to provide a tactile alert.

Clause 16. The non-transitory computer-readable medium of clause 11, wherein analyzing the received image or detection data comprises classifying each detected object into one of a plurality of object categories based on object detection and object identification modules.

Clause 17. The non-transitory computer-readable medium of clause 11, wherein analyzing the received image or detection data comprises identifying objects moving laterally across the forward path of the vehicle within the first and second cross-traffic fields of view.

Clause 18. The non-transitory computer-readable medium of clause 17, wherein the instructions further cause the one or more processors to predict a potential collision trajectory based on the detected lateral movement of an object in the cross-traffic fields of view.

Clause 19. The non-transitory computer-readable medium of clause 18, wherein the instructions further cause the one or more processors to increase the risk level when the predicted trajectory of a detected object intersects with the forward path of the vehicle.

Clause 20. The non-transitory computer-readable medium of clause 11, wherein the alert provided to the vehicle operator comprises a visual indicator highlighting the location and movement direction of a cross-traffic object relative to the vehicle.

Clause 21. The non-transitory computer-readable medium of clause 11, wherein the instructions further cause the one or more processors to distinguish between stationary and moving objects in the cross-traffic fields of view and to prioritize alerts for moving objects crossing the forward path of the vehicle.

Clause 22. The non-transitory computer-readable medium of clause 11, wherein the instructions further cause the one or more processors to provide a distinct audible or haptic alert when a cross-traffic object is detected to be entering the forward path of the vehicle.

The foregoing description of various aspects and examples have been presented for purposes of illustration and description. It is not intended to be exhaustive nor to limit the disclosure to the forms described. The embodiment(s) illustrated in the figures can, in some instances, be understood to be shown to scale for illustrative purposes. Numerous modifications are possible in light of the above teachings, including a combination of the abovementioned aspects. Some of those modifications have been discussed and others will be understood by those skilled in the art. The various aspects were chosen and described in order to best illustrate the principles of the present disclosure and various aspects as are suited to the particular use contemplated. The scope of the present disclosure is, of course, not limited to the examples or aspects set forth herein, but can be employed in any number of applications and equivalent devices by those of ordinary skill in the art.

What is claimed is:

1. A vehicle vision and detection system comprising:
a first support arm configured to be secured to a vehicle at a location in front of a vehicle windshield;
a first housing operably connected to the support arm;
one or more first cameras or detection devices disposed within the first housing and arranged to capture image or detection data corresponding to a forward field of view of the vehicle;
a second support support arm configured to be secured to the vehicle at a second location in front of the vehicle windshield;
a second housing operably connected to the support arm;
one or more second cameras or detection devices disposed within the second housing and arranged to capture image or detection data corresponding to a forward field of view of the vehicle;
one or more processors operably connected to the first and second one or more cameras or detection devices and configured to:
receive image or detection data from the one or more first or second cameras or detection devices;
analyze the received image or detection data to detect objects within the forward field of view;
determine a risk level associated with each detected object based on the analyzed image or detection data; and
presenting an alert or activating a vehicle safety intervention system via an output interface based on the risk level associated with each detected object.

2. The vehicle vision and detection system of claim 1, wherein each of the first and second support arms is positioned above a hood or fender of the vehicle and forward of a front axle thereof.

3. The vehicle vision and detection system of claim 2, wherein each of the first and second housings comprises a transparent window through which the respective camera captures image data.

4. The vehicle vision and detection system of claim 1, wherein at least one of the first or second detection devices comprises a radar sensor.

5. The vehicle vision and detection system of claim 4, wherein at least one of the first or second detection devices further comprises a LIDAR sensor.

6. The vehicle vision and detection system of claim 1, wherein each of the first and second support arms has a pivotable connection to the vehicle, the pivotable connection configured to allow the respective housing to swing away from an obstacle upon impact.

7. The vehicle vision and detection system of claim 1, wherein the one or more processors are further configured to integrate map data and navigation data stored in a data store to refine the determined risk level based on road geometry and prevailing traffic conditions.

8. The vehicle vision and detection system of claim 7, wherein the one or more processors are further configured to predict a potential collision trajectory of a detected object and increase the associated risk level when the predicted trajectory intersects a forward path of the vehicle.

9. The vehicle vision and detection system of claim 2, wherein the first and second support arms and their respective housings are aerodynamically shaped with rounded front portions to reduce wind drag.

10. The vehicle vision and detection system of claim 1, wherein the one or more processors are further configured to classify each detected object into one of a plurality of object categories based on object detection and identification modules.

11. The vehicle vision and detection system of claim 1, wherein the one or more processors are further configured to distinguish between stationary and moving objects within the forward field of view and prioritize alerts for moving objects entering the vehicle's path.

12. The vehicle vision and detection system of claim 1, wherein the alert presented to the vehicle operator comprises at least one of a visual indicator on a vehicle display, an audible output, or a haptic actuator.

13. The vehicle vision and detection system of claim 1, further comprising at least one additional camera disposed within at least one of the first or second housings, the additional camera arranged to capture image data corresponding to a cross-traffic field of view on opposite sides of the vehicle.

14. The vehicle vision and detection system of claim 13, wherein the one or more processors are further configured to receive image data from the additional camera, analyze the received image data to detect objects within the cross-traffic field of view, determine a risk level, and cause the output interface to provide a cross-traffic alert based on the determined risk level.

15. The vehicle vision and detection system of claim 1, wherein each of the first and second housings houses a printed circuit board configured to preprocess signals from the respective cameras or detection devices.

16. A non-transitory computer-readable medium storing instructions that, when executed by one or more processors of a vehicle vision and detection system comprising:
a first support arm configured to be secured to a vehicle at a location in front of a vehicle windshield;
a first housing operably connected to the first support arm;
one or more first cameras or detection devices disposed within the first housing and arranged to capture image or detection data corresponding to a forward field of view of the vehicle;
a second support arm configured to be secured to the vehicle at a second location in front of the vehicle windshield;
a second housing operably connected to the second support arm;
one or more second cameras or detection devices disposed within the second housing and arranged to capture image or detection data corresponding to a forward field of view of the vehicle;
cause the one or more processors to perform operations comprising:
receiving image or detection data from the one or more first cameras or detection devices and the one or more second cameras or detection devices;
analyzing the received image or detection data to detect objects within the forward field of view;
determining a risk level associated with each detected object based on the analyzed image or detection data; and
presenting an alert or activating a vehicle safety intervention system via an output interface based on the risk level associated with each detected object.

17. The non-transitory computer-readable medium of claim 16, wherein each of the first and second support arms is positioned above a hood or fender of the vehicle and forward of a front axle thereof.

18. The non-transitory computer-readable medium of claim 16, wherein at least one of the first or second detection devices comprises a radar sensor, and at least one of the first or second detection devices comprises a LIDAR sensor.

19. The non-transitory computer-readable medium of claim 16, further storing instructions that, when executed, cause the one or more processors to:
receive image data from at least one additional camera disposed within at least one of the first or second housings, the additional camera arranged to capture image data corresponding to a cross-traffic field of view on opposite sides of the vehicle;
analyze the received image data to detect objects within the cross-traffic field of view;
determine a risk level associated with each detected object; and
cause the output interface to provide a cross-traffic alert based on the determined risk level.
